(19) United States
(12) Patent Application Publication
(10) Pub. No.: US 2026/0015237 A1
(43) Pub. Date: Jan. 15, 2026

(54) CASCADED COMPRESSION OF THE SIZE DISTRIBUTION OF ZERO-DIMENSIONAL NANOSTRUCTURES

(71) Applicant: MASSACHUSETTS INSTITUTE OF TECHNOLOGY, Cambridge, MA (US)

(72) Inventors: Jiangtao WANG, Cambridge, MA (US); Chi David CHENG, Cambridge, MA (US); Jing KONG, Cambridge, MA (US)

(21) Appl. No.: 19/152,827

(22) PCT Filed: May 13, 2024
(86) PCT No.: PCT/US2024/029172

§ 371 Date: Jul. 31, 2025

Related U.S. Application Data
(60) Provisional application No. 63/502,064, filed on May 12, 2023.

(51) Int. Cl. C01B 32/188; C01B 32/194

(52) U.S. Cl. CPC C01B 32/188; C01B 32/194; C01B 2204/02; C01P 2006/16

(57) ABSTRACT

Systems and methods for cascaded compression of zero-dimensional nanostructures (0DNs) ae disclosed. The cascaded compression approach can be used to narrow the size distribution of nanopores with left skewness and ultra-small tail deviation, while keeping the density of nanopores increasing at each compression cycle. In some embodiments, a size distribution of existing nanopores can be compressed by a combination of shrinkage and expansion, with a new batch of nanopores being created, which can lead to increased nanopore density at the completion of each cycle. Moreover, cascaded compression of the 0DNs can allow for independent control of nanopore density, the mean diameter, the standard deviation, and the skewness of the size distribution.

### CROSS-REFERENCE TO RELATED APPLICATION

The present disclosure claims priority to and the benefit of U.S. Provisional Application No. 63/502,064, entitled “Cascaded Compression of the Size Distribution of Zero-Dimensional Nanostructures,” filed on May 12, 2023, the content of which is incorporated by reference herein in its entirety.

### STATEMENT REGARDING FEDERALLY SPONSORED RESEARCH OR DEVELOPMENT

This invention was made with government support under W911NF-18-1-0432 awarded by the U.S. Army Research Office. The government has certain rights in the invention.

### FIELD

The present disclosure relates to systems and methods for a cascaded compression approach to narrowing the size distribution of nanopores in various materials, and more particularly relates to formation of high-density nanopores in a material to allow for independent control of several metrics of the generated nanopores.

### BACKGROUND

Zero-dimensional nanostructures (0DNs), such as nanoparticles and nanopores, possess unique mechanical, optical, and physiochemical properties that make them desirable for various applications. For example, monolayer graphene with nanometer-scale pores, atomically thin thickness, and remarkable mechanical properties can provide wide-ranging opportunities for applications in ion and molecular separations, energy storage, and electronics.

Conventionally, because the performance of these applications tends to rely heavily on the size of the nanopores, precision of design and engineering of a suitable nanopore size with narrow size distributions is desired, but has proven difficult. Efforts to achieve this have suffered from several shortcomings. For example, top-down processes can yield lognormal distributions with long tails, particularly at the sub-nanometer scale. For example, a lognormal nanopore size distribution (which is right-skewed) is limiting when it comes to size-based ion/molecular separations because the peak diameter and the tail deviation of a distribution are intrinsically coupled. Moreover, the size distribution and density of the nanopores can often be intrinsically intercorrelated, leading to a trade-off between the two that substantially limits their applications, as described in greater detail below.

Accordingly, there is a need for improved techniques for fine tuning size distribution and other parameters in nanostructural materials.

### SUMMARY

The present application is directed to systems and methods for cascaded compression of zero-dimensional nanostructures (0DNs). Specifically, the cascaded compression approach of the present embodiments can be used to narrow the size distribution of nanopores with left skewness and ultra-small tail deviation, while keeping the density of nanopores increasing at each compression cycle. In some embodiments, the formation of nanopores can be split into a number of incremental steps, in each of which the size distribution of all the existing nanopores can be compressed by a combination of shrinkage and expansion. Moreover, during the expansion process, a new batch of nanopores can be created, leading to increased nanopore density at the completion of each cycle. As a result, high-density nanopores with a left-skewed, short-tail size distribution can be obtained that show ultrafast and angstrom size-tunable selective transport of ions and molecules, breaking the limitation of the conventional lognormal size distribution. Further still, the methods of the present embodiments can allow for independent control of several metrics of the generated nanopores, including the density, the mean diameter, the standard deviation, and the skewness of the size distribution, which can lead to further progress in the nanotechnology space.

One exemplary embodiment of a method of modifying a material includes placing an electrode of an electrode-substrate assembly over a substrate, applying a continuous monolayer film over the substrate, applying a voltage to the substrate to produce zero-dimensional nanostructures in the lattice, and controlling production of the zero-dimensional nanostructures by independently tuning each of one or more of a density, a mean diameter, a standard deviation, or a skewness of a size distribution of the produced zero-dimensional structures is independently tuned.

In some embodiments, the method can further include preloading the electrode with one or more particles by one or more of e-beam evaporation or in-situ electrochemical deposition prior to production of the zero-dimensional nanostructures. The electrode can be placed substantially parallel to the substrate. The substrate can include a copper foil substrate, hexagonal boron nitride (hBN), molybdenum disulfide (MoS₂), 2D materials, or their stacking structures. The electrode can include a grounded graphite electrode.

The voltage can induce particles from the electrode to travel to the substrate to expand a size of the zero-dimensional nanostructures that are formed in the lattice. In some embodiments, the zero-dimensional nanostructures can include one or more nanopores. The one or more nanopores can be formed in a graphene lattice. In some embodiments, the continuous monolayer film can be a graphene film that includes a growing graphene lattice. The lattice can grow during production of the zero-dimensional nanostructures.

In some embodiments, the method can include turning off the voltage to induce shrinkage of the zero-dimensional nanostructures in the lattice. Applying the voltage to the substrate and turning off the voltage to induce shrinkage can be alternately repeated. In some embodiments, it can be alternate repeated about five times, or from about five times to about twenty times. A diameter distribution of the zero-dimensional nanostructures can be compressed when repeating of applying the voltage to the substrate and turning off the voltage to induce shrinkage.

The density of the zero-dimensional nanostructures can increase linearly with reaction time. In some embodiments, the density of the zero-dimensional nanostructures can be decoupled from one or more of the relative standard deviation or the size of the zero-dimensional nanostructures. Controlling production of the zero-dimensional nanostructures can include independently tuning two or more of the density, the mean diameter, the standard deviation, and/or the skewness of a size distribution of the produced zero-dimensional structures. In some embodiments, controlling production of the zero-dimensional nanostructures can include independently tuning three or more, or all four, of the density, the mean diameter, the standard deviation, and/or the skewness of a size distribution of the produced zero-dimensional structures. In some embodiments, the zero-dimensional nanostructures can include a left-skewed, short-tail size distribution having ultrafast and angstrom size-tunable selective transport of ions and molecules.

One exemplary composition includes a continuous monolayer film. The film has a growing lattice that includes zero-dimensional nanostructures formed in the lattice, with the growing lattice occurring during expansion of the zero-dimensional nanostructures. The zero-dimensional nanostructures are configured to be independently tuned in one or more of a density, a mean diameter, a standard deviation, or a skewness of a size distribution of the produced zero-dimensional structures.

The zero-dimensional nanostructures can include one or more nanopores. The one or more nanopores can be formed in a graphene lattice. In some embodiments, the continuous monolayer film can be a graphene film that includes a growing graphene lattice. The zero-dimensional nanostructures can include a left-skewed, short-tail size distribution having ultrafast and angstrom size-tunable selective transport of ions and molecules.

A mean diameter of the zero-dimensional nanostructures can be less than about 1 nanometer. A density of the zero-dimensional nanostructures can be decoupled from one or more of relative standard deviation or size of the zero-dimensional nanostructures. In some embodiments, a density of the zero-dimensional nanostructures can increase linearly with reaction time. The zero-dimensional nanostructures in the lattice can be configured to shrink in the absence of an electric field.

### BRIEF DESCRIPTION OF THE DRAWINGS

This disclosure will be more fully understood from the following detailed description taken in conjunction with the accompanying drawings, in which:

FIG. 1A is a schematic representation of an electrode-substrate assembly showing creation and expansion of nanopores in a monolayer graphene film by in-situ copper sputtering from an electrode positioned in parallel to the graphene in the presence of an electric field;

FIG. 1B is a schematic representation of the electrode-substrate assembly of FIG. 1A having copper particles preloaded onto the electrode;

FIG. 1C is a scanning transmission electron microscopy (STEM) of an example embodiment of nanopores of FIG. 1A being created on the monolayer graphene film;

FIG. 1D is a Raman spectrum graph of the graphene film after application of the electric field in the electrode-substrate assembly of FIG. 1A;

FIG. 2A is a schematic representation of an electrode-substrate assembly with the electrode lacking copper particles being preloaded thereon with no nanopores being formed in a layer of the monolayer graphene film in the presence of an electric field;

FIG. 2B is a schematic representation of an electrode-substrate assembly having a flat copper electrode that is covered by graphene with no nanopores being formed in a layer of the monolayer graphene film in the presence of an electric field;

FIG. 2C is a Raman spectrum graph of the graphene film after application of the electric field in the electrode-substrate assembly of FIG. 2A;

FIG. 2D is a Raman spectrum graph of the graphene film after application of the electric field in the electrode-substrate assembly of FIG. 2B;

FIG. 3A is an optical image of an example embodiment of a sample of nanoporous graphene film on a copper substrate;

FIG. 3B is an optical image of the sample of FIG. 3A after being immersed in about 80° C. water for about five (5) minutes;

FIG. 3C is an optical image of the sample of FIG. 3A after being oxidized in about 150° C. ambient air for about two (2) minutes;

FIG. 3D is an optical image of the sample of FIG. 3A after oxidation, in which only the indicated region was overlapped with the graphite electrode and sputtered;

FIG. 4A is a schematic representation of the assembly of FIG. 1A with the electric field turned off;

FIG. 4B is a schematic representation of the evolution of the probability density of nanopore diameter within two compression cycles;

FIG. 4C is a graph illustrating the schematic evolution of nanopore density, mean diameter, and relative standard deviation vs. time based on the derived equations, with t_{E} and T referring to the expansion time and the periodic time of one compression cycle, respectively;

FIG. 5A is a schematic representation of an alternate embodiment of an electrode-substrate assembly for nanopore fabrication by in-situ argon sputtering from an electrode positioned in parallel to a graphene film in the presence of an electric field;

FIG. 5B is a Raman spectrum graph of the graphene film after application of the electric field in the electrode-substrate assembly of FIG. 5A;

FIG. 5C is a schematic representation of the assembly of FIG. 5A with the electric field turned off;

FIG. 6A is a Raman spectra graph of the nanoporous graphene of FIG. 3A with various compression cycles;

FIG. 6B is a graph illustrating intensity ratio between the D band and G band of the samples after single expansion vs. shrinkage time and an inset (i) photograph of a topographic defect;

FIG. 6C is a graph illustrating Relationship between the diameter and shrinkage time derived from the data of FIG. 6B;

FIG. 6D is a graph illustrating linear evolution of nanopore density by single expansion and compression cycles;

FIG. 6E is a graph illustrating evolution of diameter by single expansion or by multiple compression cycles;

FIG. 6F is a graph illustrating diameter changes with the compression factor;

FIG. 7A is a schematic representation of a scanning electron microscopy (SEM) image of nanoporous graphene deposited on a polyimide track-etched membrane with an inset (i) of a nanoporous graphene membrane; and

FIG. 7B is a magnified schematic representation showing the size-based nanofiltration of Rose Bengal across nanoporous graphene membranes in methanol.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Terms commonly known to those skilled in the art for components and/or processes of the systems, methods, and compositions disclosed herein and the like may be used interchangeably herein. A person skilled in the art, in view of the claims, present disclosure, and knowledge of the skilled person, will understand such terms are merely examples of such systems, methods, and/or compositions are possible.

The present disclosure generally relates to systems and methods for use of cascaded compression to create nanopores in materials. Specifically, cascaded compression can be used to design and engineer with precision a suitable nanopore size with narrow size distributions. The formation of nanopores can be split into several incremental steps and/or cycles, in each of which the size distribution of all the existing nanopores can be compressed by a combination of shrinkage and expansion, while creating a new batch of nanopores, which increases nanopore density in each cycle. Creation of nanopores during expansion of previously-formed nanopores can allow for independent control of a number of nanopore control parameters, including the density, the mean diameter, the standard deviation, and/or the skewness of the size distribution of the generated nanopores. Moreover, the technique of the present embodiments can create highly adjustable and controllable nanopores with sub-nanometer precision. For example, controlling nanopore parameters for the purposes of this disclosure can include independently tuning each of one or more of a density, a mean diameter, a standard deviation, and/or a skewness of a size distribution of the produced zero-dimensional structures, which can allow customization of these parameters in various combinations. In some embodiment, the nanopore parameters can be controlled by independently tuning two or more of the density, the mean diameter, the standard deviation, and/or the skewness of a size distribution of the produced zero-dimensional structures, three or more of the nanopore parameters, or all four of the nanopore parameters.

### Introduction and Modeling of Cascaded Compression

To illustrate the concept of cascaded compression in the provided disclosure, the evolution of a batch of isolated model zero-dimensional nanostructures (0DNs) with a constant number density can be examined. 0DNs having a constant number density refers to a process for nanopore formation in which the size distribution of all the existing nanopores is compressed by a combination of shrinkage and expansion while no new 0DNs are generated during evolution. Without the consideration of any self-sharpening process, e.g., in colloidal crystal, the size of 0DNs can be generally approximated as a lognormal distribution with a mean diameter of d̅₀ and a standard deviation (SD) of σ₀. For any given expansion and shrinkage mechanisms, the final diameters of the 0DNs can be treated as a transformation of the originals. If the transformation is linear and one cycle of compression operation is defined as staring with a shrinkage and ending with an expansion step, Equations (1) and (2) can be applied:

$$shrinkage : {d}_{S} = {α}_{S} {d}_{0} + {δ}_{S} \qquad ( 1 )$$

$$expansion : {d}_{E} = {α}_{E} {d}_{S} + {δ}_{E} \qquad ( 2 )$$

where d₀ is the initial diameter of one specific 0DN, and α_{S}, α_{E} and δ_{S}, δ_{E} are the compression factors and off-set values for the shrinkage and expansion, respectively. Plugging equation (1) into (2), the mean diameter d̅ₖ and SD σₖ after k cycles of compression of a 0DN ensemble become geometric series with the compression cycle k:

$${\overline{d}}_{k} = ( {\overline{d}}_{0} - {d}_{∞} ) {( {α}_{E} {α}_{S} )}^{k} + {d}_{∞} \qquad ( 3 )$$

$${σ}_{k} = {( {α}_{E} {α}_{S} )}^{k} {σ}_{0}$$

in which d_{∞} equals to

$$\frac{{α}_{E} {δ}_{S} + {δ}_{E}}{1 - {α}_{E} {α}_{S}} .$$

When α_{E}α_{S}<1, the SD of size distribution decreases with the compression cycle and the mean diameter has an asymptotic value of d_{∞}. In a practical process of cascaded compression, each cycle of operation can involve the generation of a new batch of 0DNs. Under the assumptions that the generation, shrinkage, and expansion of 0DNs are the same and independent for each batch, the mean diameter and SD of the 0DNs ensemble after n cycles can be the cascades of those of the n+1 batches of 0DNs, and can be related to d̅ₖ as,

$$\begin{matrix}{\overline{d}}_{n} = \frac{1}{n + 1} {\sum }_{0}^{n} {\overline{d}}_{k} \\ = {d}_{∞} - \frac{1 - {( {α}_{E} {α}_{S} )}^{n + 1}}{( n + 1 ) ( 1 - {α}_{E} {α}_{S} )} ( {d}_{∞} - {\overline{d}}_{0} )\end{matrix} \qquad ( 4 )$$

$${σ}_{n} \approx \sqrt{\frac{{σ}_{0}^{2} + {( {\overline{d}}_{0} - {d}_{∞} )}^{2} / ( 1 + {α}_{E} {α}_{S} )}{( n + 1 ) ( 1 - {α}_{E} {α}_{S} )}} \qquad ( 5 )$$

When the cascaded number is large, the mean diameter d̅ₙ approaches d_{∞}, becoming independent of the initial size distribution, and the SD σₙ decreases with the square root of cascade number. This model can indicate that the metrics (including mean diameter, SD, skewness, etc.) of 0DNs size distribution can be independently targeted and designed using the process of cascaded compression. To apply this model in a real case, a shrinkage or expansion mechanism that has a total compression factor α_{E}α_{S} smaller than 1 should first be identified.

### Nanopore Generation by Cascaded Compression

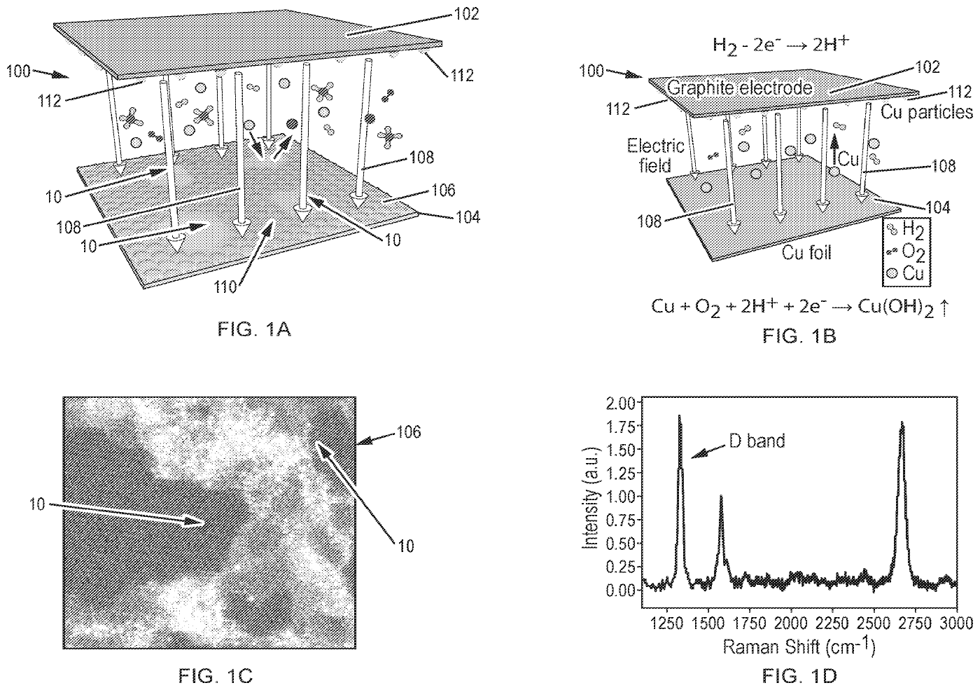

Cascaded compression can be used to create nanopores in a variety of substances. For example, FIGS. 1A-1D illustrate an electrode-substrate assembly 100 for creation and expansion of nanopores 10 on graphene 106 by in-situ Cu sputtering. The electrode-substrate assembly 100 can include an electrode 102, e.g., a graphite electrode, positioned relative to a substrate 104 having a graphene film 106 formed thereon.

As shown, the electrode 102, e.g., an anode, can be placed over the substrate 104, e.g., copper (Cu) foil, which serves as a cathode, while an electric field 108 is turned on to induce sputtering for nanopore creation. The electrode 102 can be oriented in parallel, or substantially in parallel relative to the substrate 104 to encourage uniform distribution of charge across the electrode-substrate assembly. It will be appreciated that “substantially in parallel” for the purpose of this disclosure can refer to the electrode being oriented within about 5 degrees of parallel, within about 4 degrees of parallel, within about 3 degrees of parallel, within about 2 degrees of parallel, within about 1 degree of parallel, and/or within about 0.5 degrees of parallel, with smaller degree values typically leading to superior performance in some instances. In some embodiments, the copper foil 104 can have the continuous monolayer graphene film 106 formed thereon, with the film 106 having a growing graphene lattice 110 that defines a series of pores. In some embodiments, the continuous monolayer graphene film 106 can grow in a low-pressure chemical vapor deposition (LPCVD) chamber. Sputtering can occur due to the presence of the voltage of the electric field 108, which can send copper particles, e.g., copper ions, from the graphite electrode 102 towards the copper foil 104 to expand a size of the nanopores 10 that are formed in the lattice 110.

While the present disclosure discusses nanopore 10 generation using graphene electrodes, it will be appreciated that the present disclosure need not be limited to graphene and can be applied to electrodes having various substances in lieu of, or in addition to, graphene. For example, some non-limiting embodiments of the electrode can include copper, hexagonal boron nitride (hBN), molybdenum disulfide (MoS₂), and so forth, as well as 2D materials, and/or their stacking structures. Moreover, while the present disclosure discusses nanopore 10 generation in a continuous monolayer graphene film 106, it will be appreciated that the present disclosure need not be limited to graphene and can be applied to various substances that include 0DNs in lieu of, or in addition to, graphene. It will be appreciated that alternate substrate materials that can be used can include hBN, MoS₂, and so forth, as well as 2D materials, and/or their stacking structures.

In some embodiments, one or more copper particles 112 can be deposited, e.g., preloaded to the graphite electrode 102 for in situ sputtering. For example, in at least some instances, preloading of the Cu particles 112 onto the electrode 102 can occur by e-beam evaporation and/or in-situ electrochemical deposition prior to growth of the graphene film. As shown in FIG. 1B, in the presence of the electric field 108, a surface electrochemical reaction can change Cu to Cu(OH)₂, which is easier to evaporate. After formation of Cu(OH)₂ particles, these particles can be reduced to Cu on the graphite electrode in the atmosphere of H₂, thereby preloading them for sputtering.

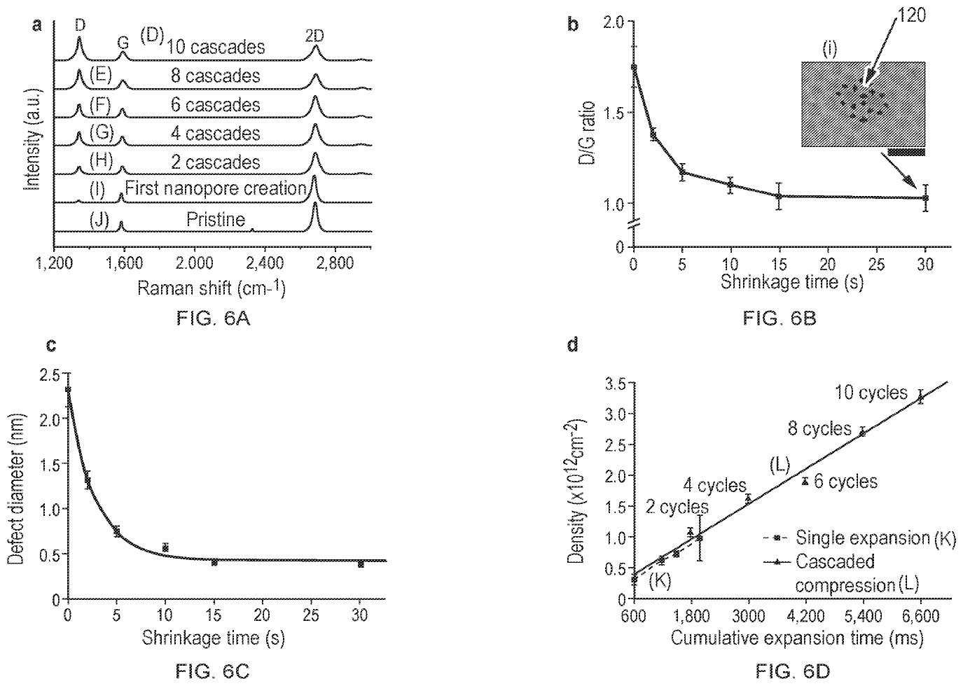

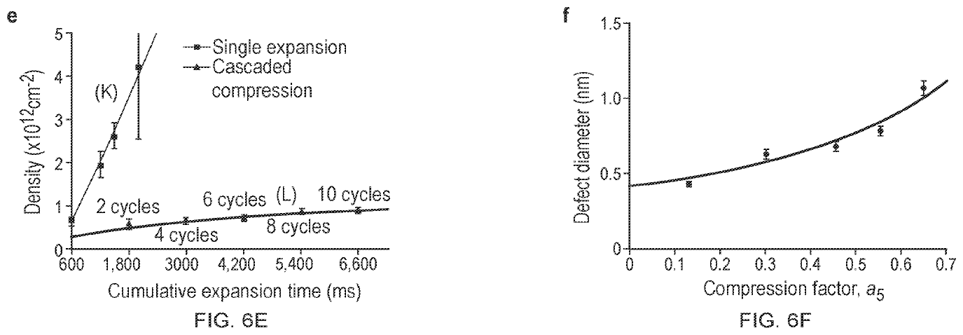

When a negative voltage is applied onto the copper substrate, the Cu particles 112 on the graphite electrode 102 can be ionized, accelerated, and hit the substrate, causing sputtering of the carbon atoms from the growing graphene lattice 110, as shown in FIG. 1C, which is a scanning transmission electron microscopy (STEM) image of an example of the nanopores 10 created by the assembly 100 in FIG. 1A. The diametric expansion rate of nanopores 10 can be constant for sputter etching, with a diameter after a sputtering time of t_{E} being d(t_{E})=d₀+δ_{E}(t_{E}). In this scenario, it can be seen that α_{E}=1 (see FIG. 6E, discussed below), and δ_{E}(t_{E})=constant·t_{E}.

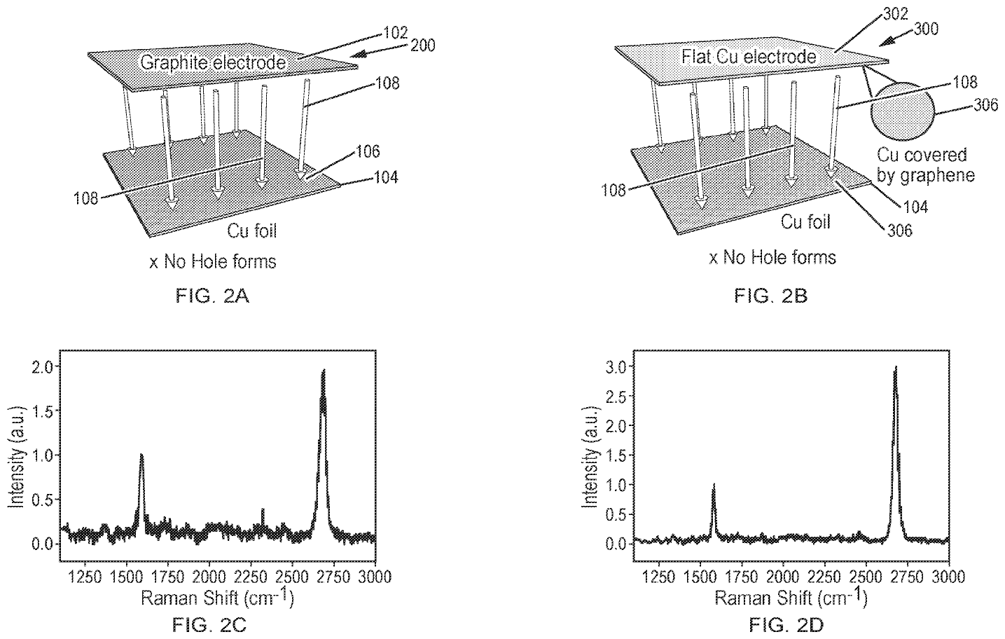

FIG. 1D illustrates a Raman spectrum of the graphene film 106 after applying the electric field 108 to the preloaded anode (electrode 102) of FIG. 1A using the approach described above with respect to FIG. 1B. As shown, a D-band of high intensity occurs at a Raman shift at about 1300 cm⁻¹, proving that the in situ sputter results in the presence of exposed Cu particles at the anode 102. The importance of exposed Cu particles 112 at the anode 102 is well illustrated when comparing the Raman spectrum of FIG. 1D to FIGS. 2A-2D, with FIGS. 2A and 2B illustrating alternate electrode-substrate assembly embodiments 200, 300, and FIGS. 2C and 2D illustrating their respective corresponding Raman spectra.

As shown in FIG. 2A, a graphite electrode 102 having no exposed Cu particles, e.g., a graphite electrode that does not have Cu particles preloaded thereto prior to growth of the graphene film 106 as in the present embodiments, does not form nanopores on the graphene film 106 formed on the substrate 104 in the presence of the electric field 108. Similarly, FIG. 2B illustrates a flat Cu electrode 302 that is covered by graphene 106 also does not form nanopores on the graphene film 106 formed on the substrate 104 in the presence of the electric field 108. This is confirmed by the Raman spectra of FIGS. 2C-2D, which illustrate no D-band for the configurations of FIGS. 2A-2B. When compared to the spectrum of FIG. 1D, the larger area of exposed Cu that occurs due to the preloading in FIG. 1A results in a stronger copper effect, which leads to nanopore expansion in the lattice 110 formed on the substrate, e.g., copper foil 104.

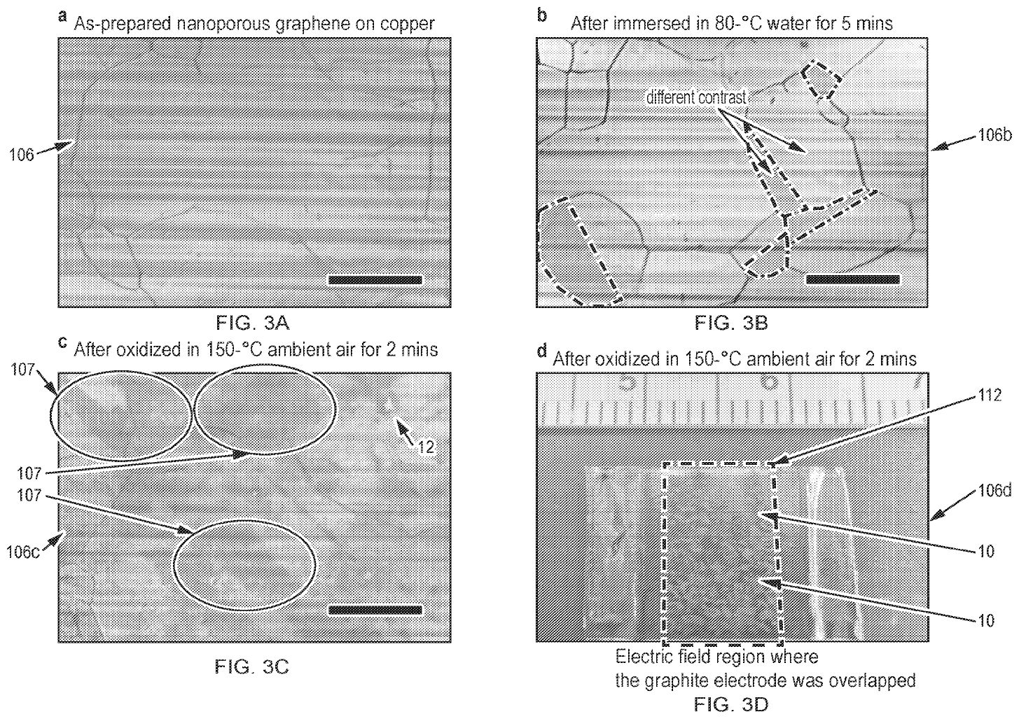

FIGS. 3A-3D illustrate optical images of the graphene film 106 of FIG. 1A after in-situ sputtering. For example, FIG. 3A illustrates an optical image of the as-prepared nanoporous graphene 106 on the copper substrate 104, while FIG. 3B illustrates an optical image of an as-prepared nanoporous graphene 106b after being immersed in about 80° C. water for about five (5) minutes. The contrast shows the wet-oxidation of different copper domain by water, suggesting the presence of nanopores 10 in the graphene films 106, 106b. FIG. 3C illustrates an optical image of a graphene film 106c after being oxidized in about 150° C. ambient air for about two (2) minutes. The color change of the film 106c, which can be seen as darker shades, such as those in regions 107 in the grayscale drawing of FIG. 3C, indicates Cu oxidation due to nanopores 10 in the graphene films 106, 106b, 106c, as compared to the films 106, 106b of FIGS. 3A and 3B. Moreover, the arrow in FIG. 3C indicates a bilayer island 12 that is not oxygen-permeable. FIG. 3D illustrates an optical image of the whole sample of the graphene film 106d after oxidation. in which only an indicated region 112 was overlapped with the graphite electrode 102 and sputtered. As shown, the region 11 of the graphene film 106d has a significantly larger number of nanopores 10 than the remainder of the film 106d, e.g., the non-overlapped region.

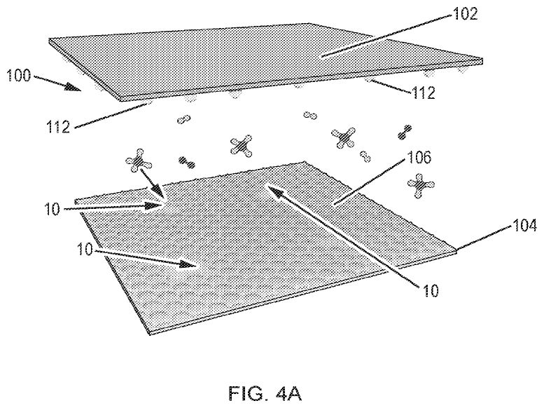

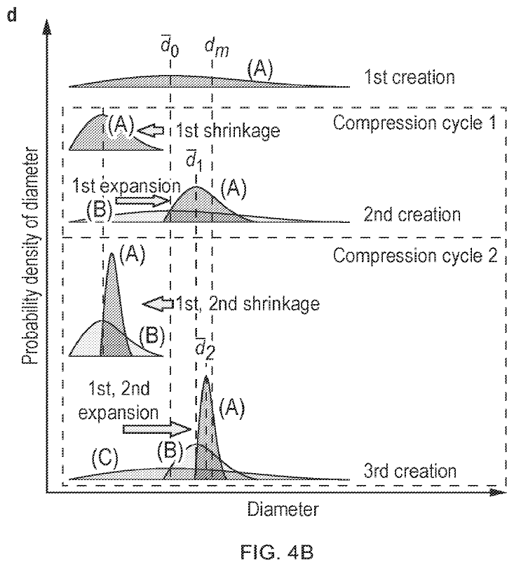

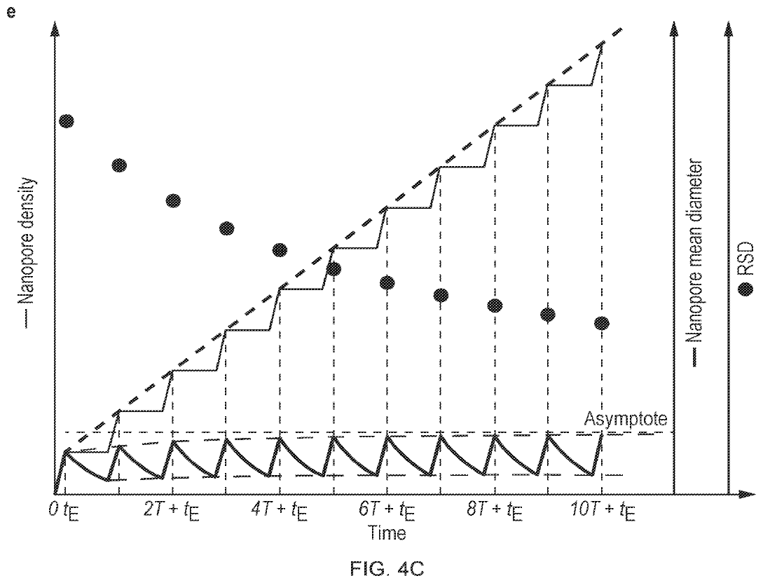

FIG. 4A illustrates the electrode-substrate assembly 100 when the electric field 108 is turned off. As shown, the electrode-substrate assembly 100 can experience spontaneous shrinkage of the nanopores 10 when the electric field 108 is turned off, while the growth of graphene 106 continues with the presence of CH₄. For the purpose of the present disclosure, turning off the electric field can include turning off the voltage for at least two (2) seconds, at least five (5) seconds, at least 10 seconds, at least 15 seconds, at least 20 seconds, and/or at least 30 seconds before voltage is applied, e.g., turned on. In some embodiments, turning the electric field 108 on and off can be alternately repeated a plurality of times. For example, in some embodiments, applying voltage to the substrate 104 to induce growth and then turning the electric field off to induce shrinkage can be repeated a plurality of times, e.g., about two times, about three times, about five times, about ten times, about twenty times, and/or approximately in a range from about five times to about twenty times. It will be appreciated that for the purposes of this disclosure, the term “about” when discussed in relation to the number of times the electric field 108 is turned on and off can encompass instances in which the electric field is turned on an extra time than it is turned off, or vice versa. Moreover, “about five times” can refer to four times, six times, and/or seven times, and “about twenty times” can refer to nineteen times, twenty-one times, and/or twenty-two times, or as would be recognized by one skilled in the art.

Due to the fast surface diffusion and small sizes of nanopores 10, the adsorption of the carbon source on the growth substrate can be considered to the limiting step for nanopore shrinkage governed by a high adsorption energy barrier. As a result, nanopore diameter can follow an exponential decrease as a function of shrinkage time t_{S}, with d(t_{S})=α_{S}(t_{S})d(t_{E})=exp(−k_{ad}Γ_{CH}_{₄}t_{S})d(t_{E})(Γ_{CH}_{₄} refers to areal collision frequency of CH₄, and k_{ad} is the coefficient of adsorption rate.

FIG. 4B illustrates the probability density of diameter of the first two compression cycles with the above-described expansion and shrinkage dynamics of FIGS. 1A and 4A discussed above. Curves (A), (B), and (C) indicate the first, second, and third batches of created nanopores 10, respectively. As noted above, during expansion, a new batch of nanopores can be created, leading to increased nanopore density by each cycle. Each cycle starts with a shrinkage and ends with an expansion. For example, in Compression Cycle 1, after curve (A) undergoes a shrinkage, expansion follows, during which curve (B) is created and the cycle completes. Similarly, during Compression Cycle 2, after curve (B) undergoes a shrinkage, expansion follows, during which curve (C) is created and the cycle completes. As shown, the diameter distribution can be significantly compressed with the cycles, and the density of the total nanopores increases linearly.

FIG. 4C illustrates the evolution of the density, mean diameter, and relative standard deviation (RSD, \tilde{σ}=σ/d̅) of all the nanopores 10 plotted against compression time. As shown, the density can increase in a stepwise manner with the cycle number, whereas the RSD can decrease with the cascade number. Such a decoupling of density from RSD can be in contrast to the attributes of nanopores created with existing methods and presents a novel feature of the present embodiments. Moreover, the RSD can increase along with the density increase of nanopores 10 at least as a result of the coupling of nanopore creation and expansion. In the case of cascaded compression, the increase of the mean diameter can have an asymptotic value as described below:

$${d}_{∞} = \frac{δ ( {t}_{E} )}{1 - {α}_{s} ( {t}_{S} )} = \frac{{α}^{3} {Γ}_{Cu} γ {t}_{E}}{1 - exp ( - {k}_{ad} {Γ}_{{CH}_{4}} {t}_{S} )} \qquad ( 6 )$$

in which a represents the length of a single unit cell of graphene, and Γ_{Cu} and γ are the areal collision frequency of Cu ions and the sputtering yield, respectively, both depending on the applied voltage. This formula can indicate that the final mean diameter d_{∞} can be highly adjustable by tuning the time of expansion and shrinkage, at least because δ_{E} and α_{S} are both monotonic functions of time. Given the flexibility of the cascaded compression model shown in FIG. 1A, and the promising results demonstrated with nanoporous graphene 106, the cascaded compression can be versatile and applicable to many other systems of zero-dimensional nanostructures (0DNs), including both nanopores and nanoparticles.

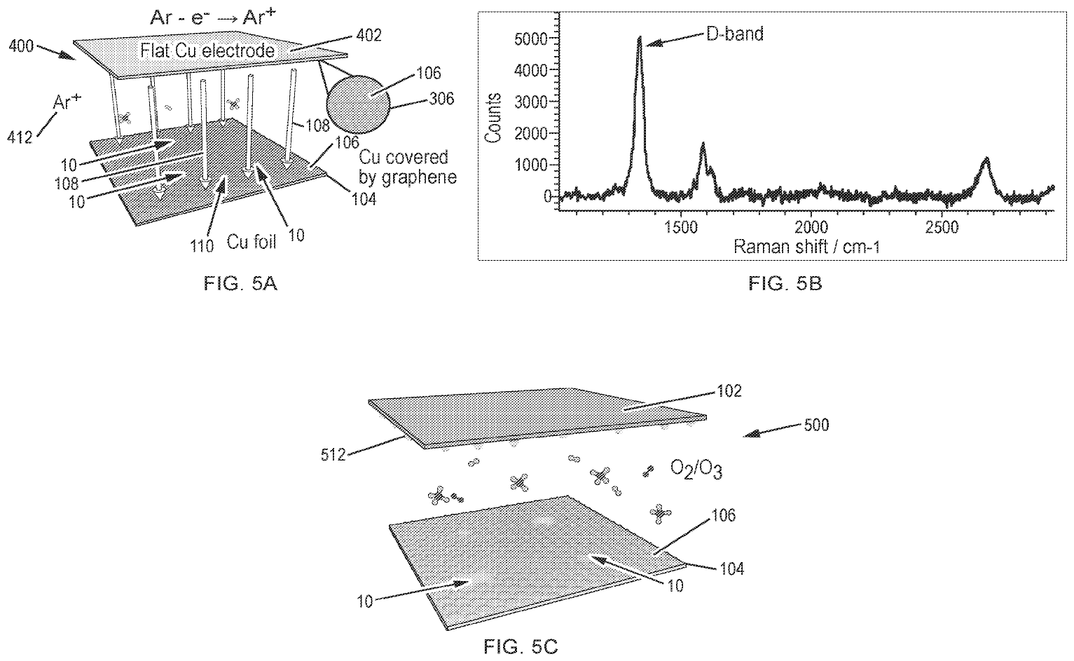

The present disclosure need not be limited to copper ion sputtering. FIGS. 5A-5C illustrate an alternate embodiment of an electrode-substrate assembly 400 for creation and expansion of nanopores 10 on graphene 106 by in-situ argon (Ar) sputtering. The electrode-substrate assembly 400 can include an electrode 402, e.g., a flat carbon electrode 402, having a graphene film 106 thereon positioned relative to a substrate 104 having a graphene film 106 formed thereon. As shown, the electrode 402, e.g., an anode, can be placed over the substrate 104, e. g., Cu foil, which serves as a cathode, while the electric field 108 is turned on to induce sputtering for nanopore creation. The electrode 402 can be oriented in parallel, or substantially parallel as defined earlier above, relative to the substrate 104 to encourage uniform distribution of charge across the electrode-substrate assembly 400. In some embodiments, the copper foil 104 and the electrode 402 can have the continuous monolayer graphene film 106 formed thereon, with the film 106 having a growing graphene lattice 110 that defines a series of pores. In some embodiments, the continuous monolayer graphene film 106 can grow in a low-pressure chemical vapor deposition (LPCVD) chamber.

Once the electric field 108 is turned on, the Ar ions 412 can be ionized at the top electrode 402, as graphene covered flat copper, as noted above. The Ar ions 412 can then be accelerated and spatter out carbon atoms in the graphene 106. Once the electric field 108 is turned off, the generated nanopore 10 can shrink with the presence of CH₄. Repeating the cycles of expansion and shrinkage can lead the cascaded compression of nanopores 10, as discussed with respect to Cu sputtering above. It will be appreciated that sputtering can occur due, at least in part, to the presence of the voltage of the electric field 108, which can send argon particles 412, e.g., argon ions, from the electrode 402 towards the copper foil 104 to expand a size of the nanopores 10 that are formed in the lattice 110.

FIG. 5B illustrates a Raman spectrum of the graphene film 106 after applying the electric field 108 to the preloaded anode (electrode 402) of FIG. 5A using the approach described above. As shown, a D-band of high intensity occurs at a Raman shift at about 1300 cm⁻¹, proving that the in situ sputter results in the presence of nanopores 10 on the graphene.

FIG. 5C illustrates an alternate embodiment for cascaded compression of nanopores of an electrode-substrate assembly 500, which incorporates the scheme of switching delivery of ozone 512 (O₃) on and off to expand and shrink the nanopores 10. The remainder of the electrode-substrate assembly 500 operates similar to that of assemblies 100, 400, and therefore a detailed discussion thereof is omitted for the sake of brevity.

FIG. 6A illustrates the use of Raman spectroscopy to characterize nanoporous graphene after various compression cycles (curves (D)-(J)) to verify the cascaded compression model. As shown, compared with the spectra of pristine graphene, the increased D-band and decreased 2D band in curve (D) can indicate that the monolayer graphene film can become increasingly defective with increasing cycles. On the contrary, after single sputtering, the pristine sample of curve (J) with the same expansion time (about two (2) seconds), D/G ratios of the samples can decrease until reaching a steady value as the shrinkage time increases, as shown in FIG. 6B. Through scanning transmission electron microscopy (STEM), the created nanopores 10 can be found to not be fully eliminated by the regrowth. Rather, about five to about seven defects 120, e.g., topological defects, and other vacancy sites can be eventually left instead, as shown in inset (i) of FIG. 6B. The presence of these defects 120 can enable the calculation of both the density and mean defect diameter of created nanopores by making a reference sample with extra 30-second regrowth time for the testing sample.

FIG. 6C shows that the derived mean defect diameters (using the D/G ratios in FIG. 6B) decrease as the shrinkage time increases. It should be noted that the nanopores 10 can have one or more disordered edges, which may inflate the derived diameters. The actual diameters that can determine the permeability of nanopores 10 are smaller, as discussed below in the characterization by atomically resolved-conductive atomic force microscopy (CAFM). Nevertheless, this size difference does not affect the analysis of the cascaded compression model.

FIGS. 6D and 6E illustrate the comparison of the nanopores 10 created by single expansion (K) and multiple compression (L) cycles using the above method. As shown, the expansion time can be about 600 milliseconds for each compression cycle. The cumulative expansion time after the n^{th} cycle is 600×(n+1) ms, so that the densities from multiple compression cycles (L) can be compared with a single expansion (K) with similar expansion time. In particular, FIG. 6D shows that the density of the created nanopores 10 is proportional to the cumulative expansion time, linearly increasing with the compression cycles. After 10 cycles, the nanopore density can reach 3.27×10¹² cm⁻², which is consistent with the observation by scanning tunneling microscope (STM). In some embodiments, the nanopore density can be uniform. The evolution of the diameters with the cumulative expansion time is shown in FIG. 6E. In the single expansion (K) without CH₄, the diameter can increase linearly, and with the increase of both density and diameter, the graphene sample 106 can become fragmented when the time of single expansion is longer than about four (4) seconds. On the contrary, the diameter of the nanopores 10 created by multiple compression cycles (L) may only slightly increase, fitting well with the cascaded compression model, the fitted shrinkage rate (or regrowth rate (k_{ad}Γ_{CH}_{₄}, 0.077 s⁻¹). After 10 cycles, the final diameter may still be smaller than about 1 nm, demonstrating the decoupling of the density and size of the nanopores 10. In some embodiments, the nanopores 10 can have an adjustable mean diameter. Further, FIG. 6F shows the dependence of defect diameter (approximates to d_{∞}) on the compression factor as predicted by the theory (equation (6)), discussed above.

The method of cascaded compression, as illustrated in the figures above, can generate a narrow and left-skewed nanopore size distribution with a peak pore diameter tailored to the specific requirements of molecular separations in graphene lattice. Such pore size distributions can break the limitation of a lognormal distribution and simultaneously deliver high permeance and high selectivity. As discussed above, a lognormal nanopore size distribution (which is right-skewed) may be limiting when it comes to size-based ion/molecular separations because the peak diameter and the tail deviation of a distribution are intrinsically coupled. For example, as the peak diameter grows larger, the tail deviation intrinsically increases. Moreover, for size-based molecular separations using monolayer nanoporous graphene, the separation selectivity for the lognormal distribution can be governed by the tail rather than the peak diameter. As such, to achieve high selectivity for a lognormal distributed nanopore ensemble is to shorten the tail region, which can reduce both the peak and average pore sizes, which may significantly sacrifice permeance. On the contrary, the peak diameter of the left-skewed distribution enabled by the cascaded compression method of the present embodiments may be highly adjustable and the tail deviation can decrease with the compression cycles. As a result, the nanopores created by cascaded compression can simultaneously lead to high permeance for target molecules and high selectivity among species having sub-angstrom close sizes, e.g., Li⁺/Ca²⁺=21, Fe³⁺/Al³⁺=15, Mg²⁺/Al³⁺=31, and He/SF₆=86 (at 230° C. with He permeance of 3.54×10⁴ gas permeation units (GPU), breaking the limitation of the lognormal size distribution.

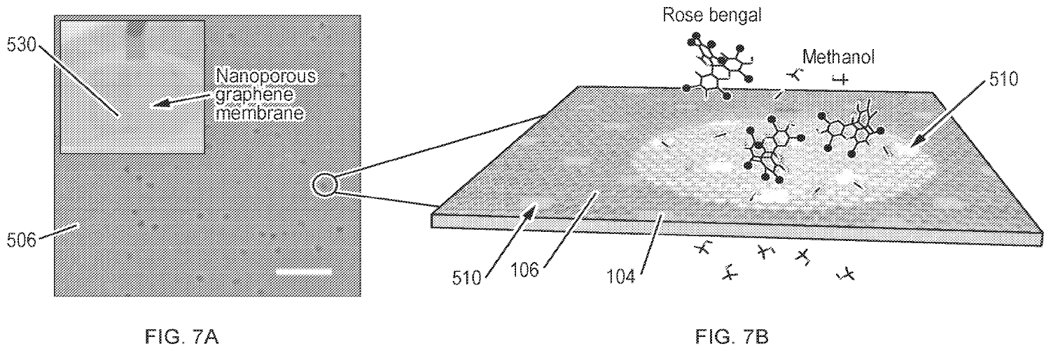

To investigate the properties of graphene nanopores 10 created by cascaded compression, coupon sized membranes can be fabricated using the as-created nanoporous graphene to test solvent permeation and nanofiltration of small organic molecules. FIG. 7A illustrates an example embodiment of an SEM image of a nanoporous graphene 106 transferred onto a polyimide track-etched membrane (PITEM) 530, with an inset photograph (i) of the nanoporous graphene membrane 530. The nanoporous graphene membranes 530 can be fabricated by transferring synthesized nanoporous graphene 106 onto PITEM 530 supports with a pore diameter of 20 nm. Dead-end filtration experiments can be performed to assess both the membrane 530 permeance and rejection of small organic molecules. A consistently rising permeance with the number of compression cycles can be observed, while a high selectivity can be maintained, which is consistent with the increase in nanopore density as the compression cycle number increases, characterized by Raman spectroscopy in FIG. 6D.

A person skilled in the art would expect the selectivity to enhance with each compression cycle in the ideal compression model, given that the influence of any non-selective flow (if present) can be mitigated by the greater number of compression cycles. Accordingly, the rejection ratio can be anticipated to be the highest for 20 compression cycles. The decrease in rejection observed at 20 compression cycles (85.7% compared to 98.3% for 10 compression cycles) can be attributable to: (1) membrane fabrication variabilities such as the transfer process and the quality of the PITEM support; and/or (2) nanopore size variations across different grains in a polycrystalline Cu growth substrate, albeit the density of nanopores across two different Cu grains appear uniform. These aspects may be improved by fabricating single crystalline Cu substrates and standardizing the membrane fabrication with automation. Furthermore, the capability of cascaded compression in adjusting the average nanopore size is investigated by filtering hexane isomers through the synthesized nanoporous graphene as a function of compression cycle and compression factor. Any selectivity observed may indicate the presence of angstrom-precise nanopores approximately in the range of about 0.49 nm to about 0.65 nm of a significant fraction, which may be used for separating hexane isomer 2,2-dimethyl butane from hexane.

FIG. 7B illustrates a schematic showing the size-based nanofiltration of Rose Bengal (RB) across nanoporous graphene membranes 106 in methanol. In fact, remarkably, the cascaded compression can enable the decoupling of the nanopore size distribution and density, leading to separation of hexane isomer, and nanofiltration of RB in methanol with an ultrahigh permeance of 594.4 L m⁻²h⁻¹bar⁻¹ and rejection of 98.3%. Further, the methods of the present embodiments can allow for the generation of a left-skewed size distribution with independently tunable peak diameter and tail deviation. This enables the nanoporous graphene membrane 106 to spontaneously exhibit both high target solute permeance and highly selective transport among a range of ion/molecule pairs with close sizes, breaking the limitation of a lognormal size distribution, and proving that cascaded compression as a versatile and practical method to unleash the potential of atomically thin membranes and other systems based on 0DNs.

No isomer selectivity may be observed for nanoporous graphene created at 10 compression cycles. This is consistent with the growth of average pore size, which is 0.89 nm at 10 compression cycles. In some embodiments, α_{S} from 0.65 to 0.13 (i.e., adjusting the nanopore shrinkage time) but keeping compression cycles to 10 for three different samples, acetone permeance can be reduced from 9.1 to 0.73 L m⁻²h⁻¹bar⁻¹, while the isomer selectivity is noticeably improved with hexane enriched by 145% over 2. 2-dimethyl butane after filtering through a nanoporous graphene membrane created at a α_{S} of 0.13. The permeance reduction and the much-improved isomer selectivity indicate downward shift of the peak pore diameter as a decrease of α_{S}, which may be consistent with the cascaded compression model and experimental nanopore size characterization. The isomer selectivity observed in the membrane permeate can indicate that the potential for energy-efficient nanofiltration of alkane isomers can be an alternative to adsorption or distillation. This can be achieved in conjunction with improved structure design of atomically thin membranes to increase support porosity and minimization of background leakage.

### Experimental Methods for Nanoporous Graphene

Synthesis of nanoporous graphene film on copper foil. Before the growth, a copper foil (Alfa Aesar, 46986 Copper foil, 25-μm thick, annealed, uncoated, 99.8%) is first cleaned by sonication for one (1) minute in a 0.05 mol/L ammonia persulfate solution (deionized water (DI water): isopropyl alcohol=1:1), followed by rinsing with DI water. Then the copper foil is warped on a graphite holder to keep the flat surface and placed into the LPCVD chamber (1-inch quartz tube is used). A grounded graphite electrode is covered over the copper foil. The distance between the electrodes is adjustable (approximately in the range of about 200 μm to about 2000 μm), for example by changing the electrode structure. The furnace temperature is ramped up to about 1035° C. within about 24 minutes with the introduction of 40-sccm H₂. Then the H₂ is switched off and 1 sccm of dry air is introduced for about one (1) minute to passivate the copper surface. To deposit Cu particles on the graphite electrode 102 in situ, the sample is annealed in the atmosphere of H₂ (40 sccm) for about 5 minutes with −400 V applied on the copper foil. Next, 0.3-sccm CH₄ is added to start the growth with 0 V applied between the electrodes. After about 15 minutes growth of the graphene film 106, the CH₄ is reduced to 0.1 sccm and 0.3 sccm of dry air is added to implement the exponential-shrinkage environment for the nanopores 10 creation. When the flow rate of each component is stable, a series of 31 400 V pulses is applied on the copper foil to create the nanopores 10 on the graphene film 106. The pulse width, periodic time, and count are adjustable as needed. The on-off of the voltage is controlled be reed relays (DAT72410) of which the response time is about 3 milliseconds. Additionally, the furnace lid is opened and a cooling fan is turned on immediately for fast cooling. The detailed electric field parameters of the samples for Raman characterization and nanofiltration in

FIGS. 6A-6F and 7A-7B: The distance between the electrodes is about 250 βm; the pulse width is about 600 ms, and the periodic time varies approximately from about 3000 ms to about 12,000 ms. The detailed electric field parameters of the samples for CAMF characterization in FIGS. 6A-6F are listed below. #809: The distance between the electrodes is about 400 μm; the pulse width is about 600 ms, and the periodic time is about 3000 ms. #822: The distance between the electrodes is about 400 μm; the pulse width is about 1200 ms, and the periodic time is about 3500 ms. #825: The distance between the electrodes is about 1200 μm; the pulse width is about 3000 ms, and the periodic time is about 6000 ms. The cycle number of all these samples above is 10. #835: the distance between the electrodes is about 1200 μm; the pulse width is about 3000 ms, and the periodic time is about 6000 ms; the cycle number is 30.

### Raman Characterization of Nanoporous Graphene

Dry transfer of nanoporous graphene. The as-prepared graphene/copper foil is spin-coated by A4 PMMA with the speed of about 2500 rpm for about one (1) minute. After baking at about 70° C. for about 3 minutes, the sample may then be laminated with a layer of heat-released tape on the top. Cutting the edges of the sample and floating the sample on the copper etchant (FeCl₃) to etch out the copper substrate, the graphene/PMMA/heat-released tape may be cleansed by running water and blown-dry by N₂. Then the sample can be placed on the target SiO₂/Si substrate in a vacuum chamber (1 Torr) at about 55° C. for about 10 minutes to remove interface adsorbent, followed by hot-press at about 100° C. for about 20 minutes. After releasing the press and venting the chamber, the heat-released tape may be detached at about 100° C. The PMMA may be removed by acetone flush and then rinsed by isopropyl alcohol.

Examples of the above-described embodiments can include the following:
1. A method of modifying a material, comprising:
placing an electrode of an electrode-substrate assembly over a substrate;
applying a continuous monolayer film over the substrate, wherein the continuous monolayer film comprises a growing lattice;
applying a voltage to the substrate to produce zero-dimensional nanostructures in the lattice; and
controlling production of the zero-dimensional nanostructures by independently tuning each of one or more of a density, a mean diameter, a standard deviation, or a skewness of a size distribution of the produced zero-dimensional structures.
2. The method of example 1, wherein the voltage induces particles from the electrode to travel to the substrate to expand a size of the zero-dimensional nanostructures that are formed in the lattice.
3. The method of example 2, further comprising preloading the electrode with one or more particles by one or more of e-beam evaporation or in-situ electrochemical deposition prior to production of the zero-dimensional nanostructures.
4. The method of any of examples 1 to 3, wherein the electrode is placed substantially parallel to the substrate.
5. The method of any of examples 1 to 4, wherein the substrate comprises a copper foil substrate, hexagonal boron nitride (hBN), molybdenum disulfide (MoS₂), 2D materials, or their stacking structures.
6. The method of any of examples 1 to 5, wherein the zero-dimensional nanostructures further comprise one or more nanopores.
7. The method of example 6, wherein the one or more nanopores are formed in a graphene lattice.
8. The method of any of examples 1 to 7, wherein the continuous monolayer film is a graphene film that comprises a growing graphene lattice.
9. The method of any of examples 1 to 8, wherein the electrode comprises a grounded graphite electrode.
10. The method of any of examples 1 to 9, wherein the lattice grows during production of the zero-dimensional nanostructures.
11. The method of any of examples 1 to 10, further comprising turning off the voltage to induce shrinkage of the zero-dimensional nanostructures in the lattice.
12. The method of any of examples 1 to 11, further comprising alternately repeating applying the voltage to the substrate and turning off the voltage to induce shrinkage.
13. The method of example 12, wherein applying the voltage to the substrate and turning off the voltage is alternately repeated at least about five times.
14. The method of example 13, wherein applying the voltage to the substrate and turning off the voltage is alternately repeated from about five times to about twenty times.
15. The method of any of examples 12 to 14, wherein a diameter distribution of the zero-dimensional nanostructures is compressed when repeating of applying the voltage to the substrate and turning off the voltage to induce shrinkage.
16. The method of any of examples 1 to 15, wherein the density of the zero-dimensional nanostructures increases linearly with reaction time.
17. The method of any of examples 1 to 16, wherein the density of the zero-dimensional nanostructures is decoupled from one or more of the relative standard deviation or the size of the zero-dimensional nanostructures.
18. The method of any of examples 1 to 17, wherein controlling production of the zero-dimensional nanostructures further comprises independently tuning two or more of the density, the mean diameter, the standard deviation, or the skewness of a size distribution of the produced zero-dimensional structures.
19. The method of any of examples 1 to 18, wherein controlling production of the zero-dimensional nanostructures further comprises independently tuning three or more of the density, the mean diameter, the standard deviation, or the skewness of a size distribution of the produced zero-dimensional structures.
20. The method of any of examples 1 to 19, wherein controlling production of the zero-dimensional nanostructures further comprises independently tuning all four or more of the density, the mean diameter, the standard deviation, or the skewness of a size distribution of the produced zero-dimensional structures.
21. The method of any of examples 1 to 20, wherein the zero-dimensional nanostructures include a left-skewed, short-tail size distribution having ultrafast and angstrom size-tunable selective transport of ions and molecules.
22. A composition, comprising:
a continuous monolayer film having a growing lattice that includes zero-dimensional nanostructures formed in the lattice, with the growing lattice occurring during expansion of the zero-dimensional nanostructures,
wherein the zero-dimensional nanostructures are configured to be independently tuned in one or more of a density, a mean diameter, a standard deviation, or a skewness of a size distribution of the produced zero-dimensional structures.
23. The composition of example 22, wherein the zero-dimensional nanostructures further comprise one or more nanopores.
24. The composition of example 22 or example 23, wherein the one or more nanopores are formed in a graphene lattice.
25. The composition of any of examples 22 to 24, wherein the continuous monolayer film is a graphene film that comprises a growing graphene lattice.
26. The composition of any of examples 22 to 25, wherein the zero-dimensional nanostructures include a left-skewed, short-tail size distribution having ultrafast and angstrom size-tunable selective transport of ions and molecules.
27. The composition of any of examples 22 to 26, wherein mean diameter of the zero-dimensional nanostructures is less than about 1 nanometer.
28. The composition of any of examples 22 to 27, wherein the density of the zero-dimensional nanostructures is decoupled from one or more of relative standard deviation or size of the zero-dimensional nanostructures.
29. The composition of any of examples 22 to 28, wherein the density of the zero-dimensional nanostructures increases linearly with reaction time.
30. The composition of any of examples 22 to 29, wherein the zero-dimensional nanostructures in the lattice are configured to shrink in the absence of an electric field.

One skilled in the art will appreciate further features and advantages of the disclosure based on the above-described embodiments. Accordingly, the disclosure is not to be limited by what has been particularly shown and described, except as indicated by the appended claims. All publications and references cited herein are expressly incorporated herein by reference in their entirety.

Some non-limiting claims that are supported by the contents of the present disclosure are provided below.

What is claimed is:

1. A method of modifying a material, comprising:
placing an electrode of an electrode-substrate assembly over a substrate;
applying a continuous monolayer film over the substrate, wherein the continuous monolayer film comprises a growing lattice;
applying a voltage to the substrate to produce zero-dimensional nanostructures in the lattice; and
controlling production of the zero-dimensional nanostructures by independently tuning each of one or more of a density, a mean diameter, a standard deviation, or a skewness of a size distribution of the produced zero-dimensional structures.

2. The method of claim 1, wherein the voltage induces particles from the electrode to travel to the substrate to expand a size of the zero-dimensional nanostructures that are formed in the lattice.

3. The method of claim 2, further comprising preloading the electrode with one or more particles by one or more of e-beam evaporation or in-situ electrochemical deposition prior to production of the zero-dimensional nanostructures.

4. The method of claim 1, wherein the electrode is placed substantially parallel to the substrate.

5. The method of claim 1, wherein the zero-dimensional nanostructures further comprise one or more nanopores.

6. The method of claim 5, wherein the one or more nanopores are formed in a graphene lattice.

7. The method of claim 1, wherein the continuous monolayer film is a graphene film that comprises a growing graphene lattice.

8. The method of claim 1, wherein the lattice grows during production of the zero-dimensional nanostructures.

9. The method of claim 1, further comprising turning off the voltage to induce shrinkage of the zero-dimensional nanostructures in the lattice.

10. The method of claim 9, further comprising alternately repeating applying the voltage to the substrate and turning off the voltage to induce shrinkage.

11. The method of claim 10, wherein a diameter distribution of the zero-dimensional nanostructures is compressed when repeating of applying the voltage to the substrate and turning off the voltage to induce shrinkage.

12. The method of claim 1, wherein the density of the zero-dimensional nanostructures is decoupled from one or more of the relative standard deviation or the size of the zero-dimensional nanostructures.

13. The method of claim 1, wherein controlling production of the zero-dimensional nanostructures further comprises independently tuning two or more of the density, the mean diameter, the standard deviation, or the skewness of a size distribution of the produced zero-dimensional structures.

14. A composition, comprising:
a continuous monolayer film having a growing lattice that includes zero-dimensional nanostructures formed in the lattice, with the growing lattice occurring during expansion of the zero-dimensional nanostructures,
wherein the zero-dimensional nanostructures are configured to be independently tuned in one or more of a density, a mean diameter, a standard deviation, or a skewness of a size distribution of the produced zero-dimensional structures.

15. The composition of claim 14, wherein the continuous monolayer film is a graphene film that comprises a growing graphene lattice.

16. The composition of claim 14, wherein the zero-dimensional nanostructures include a left-skewed, short-tail size distribution having ultrafast and angstrom size-tunable selective transport of ions and molecules.

17. The composition of claim 14, wherein mean diameter of the zero-dimensional nanostructures is less than about 1 nanometer.

18. The composition of claim 14, wherein the density of the zero-dimensional nanostructures is decoupled from one or more of relative standard deviation or size of the zero-dimensional nanostructures.

19. The composition of claim 14, wherein the density of the zero-dimensional nanostructures increases linearly with reaction time.

20. The composition of claim 14, wherein the zero-dimensional nanostructures in the lattice are configured to shrink in the absence of an electric field.
